(19) United States
(12) Patent Application Publication
(10) Pub. No.: US 2002/0104921 A1
(43) Pub. Date: Aug. 8, 2002

(54) Electrical remote-control and remote-power flying saucer

(76) Inventor: Philippe Louvel, Le Plessis Robinson (FR)

Correspondence Address: Louvel Philippe, 71 Avenue Edouard Herriot, Le Plessis Robinson, 92350, FR

(21) Appl. No.: 10/048,091

(22) PCT Filed: Apr. 5, 2001
(86) PCT No.: PCT/FR01/01018

(30) Foreign Application Priority Data
May 18, 2000 (FR) OO 06337

(51) Int. Cl. B64C 15/00; B64C 29/00

(52) U.S. Cl. 244/12.1

(57) ABSTRACT

The purpose of the invention is a light aircraft, remotely supplied and remotely controlled, propelled by electrical motors coupled to propellers, this device being able to perform stationary flight and to move in the three space dimensions in a controlled way. The system includes an aircraft (1), a control unit (3) and a handling unit (4). The aircraft comprises four propellers, each of them driven by a electric motor, a gyroscopic device, tilt sensors, a yaw sensor and an extrenal protective body.

The invention also describes the method for the fliht closed loop control.

The main purpose of this invention is to provide a enjoyable and educative toy, mainly intended for indoor flight.

In a variant of the invention, the aircraft is fitted with a miniaturized video camera, in order to perform remote inspections on buildings or elements difficult to access.

### FIELD OF THE INVENTION

The present invention relates to a light aircraft, like a flying saucer, remotely controlled and remotely powered, able to perform stationary flight and to move in the three directions.

### PRIOR ART

U.S. Pat. No. 4,161,843, issued in 1979, is known. It discloses a toy aircraft fitted with four propellers driven by a single electric motor, remotely powered. The drawback of this invention is that the control of the aircraft attitude is not possible by adjusting only the speed of the motor, as supposed in the patent description.

Patent FR2737130, issued in 1997, is known. It presents a light plane with a propeller driven by an electric motor, remotely controlled and remotely powered, intended for indoor flight. But this arrangement is not able to perform stationary flight.

U.S. Pat. No. 5,672,086, issued in 1997 is known. It presents an aircraft with two propellers, powered by an on-board electrical power source, remotely and wirelessly controlled. The drawback of this invention is that according to the current technical state of the art, it does not exist any on-board battery with a sufficient power-to-weight ratio to provide enough thrust for stationary flight.

U.S. Pat. No. 5,971,320, issued in 1999, is known. It presents a helicopter, remotely powered, which includes a main rotor and three propellers fitted at the end of the blades of the main rotor. Each of the propellers are driven by a dedicated electric motor through a rotatable electric switch. The drawback of this arrangement is that the rotatable electric switch is rather complex to manufacture and the response time of the electric motors must be very efficient, thus increasing the cost of such an aircraft.

### SUMMARY OF THE INVENTION

It is an object of the provide an invention that solves the shortcomings of the prior art inventions.

The invention is an aircraft, remotely controlled and remotely supplied, powered by propellers driven by electric motors, whose characteristics enable this device to perform stationary flight and to perform controlled displacements in any of the three directions of space.

The system includes an aircraft, a control unit and a handling unit. The aircraft has four propellers, each of them driven by an electric motor. The aircraft has also a gyroscopic device, tilt sensors, yaw movement sensor, and an external protective body.

The invention provides as well a method of controlling the flight of this device.

The main goal of this invention is to provide an enjoyable and educative toy, to be operated mainly in an indoor environment.

In a another embodiment of this invention, the aircraft is fitted with an on-board videocamera, in order to perform remote inspections on building whose access is uneasy.

### BRIEF DESCRIPTION OF THE DRAWINGS

FIG. 1 shows the invention in typical use conditions.

FIG. 2 shows a top view of the interior area of the device.

FIG. 3 shows a side view of the interior area of the device.

FIG. 4 presents a perspective view of the device, showing the arrangement of the motors and the sensors.

FIG. 5 shows the general drawing of the handling unit (4) and a drawing of the movements of the control handle (7).

FIG. 6 shows the internal electric diagram of the aircraft (1).

FIG. 7 shows the internal electric diagram of the control unit (3).

FIG. 8 shows the internal electric diagram of the handling unit (4).

FIG. 9 shows the electric diagram of the closed loop control achieved by the electronic circuit (81).

FIG. 10 shows a variant of the electric diagram of the closed loop control achieved by the electronic circuit (81).

FIG. 11 shows a top view of the external body (40) of the aircraft.

FIG. 12 shows a bottom view of the external body (40) of the aircraft.

FIG. 13 shows a variant of the invention fitted with an on-board video camera (300).

### DETAILLED DESCRIPTION OF THE INVENTION

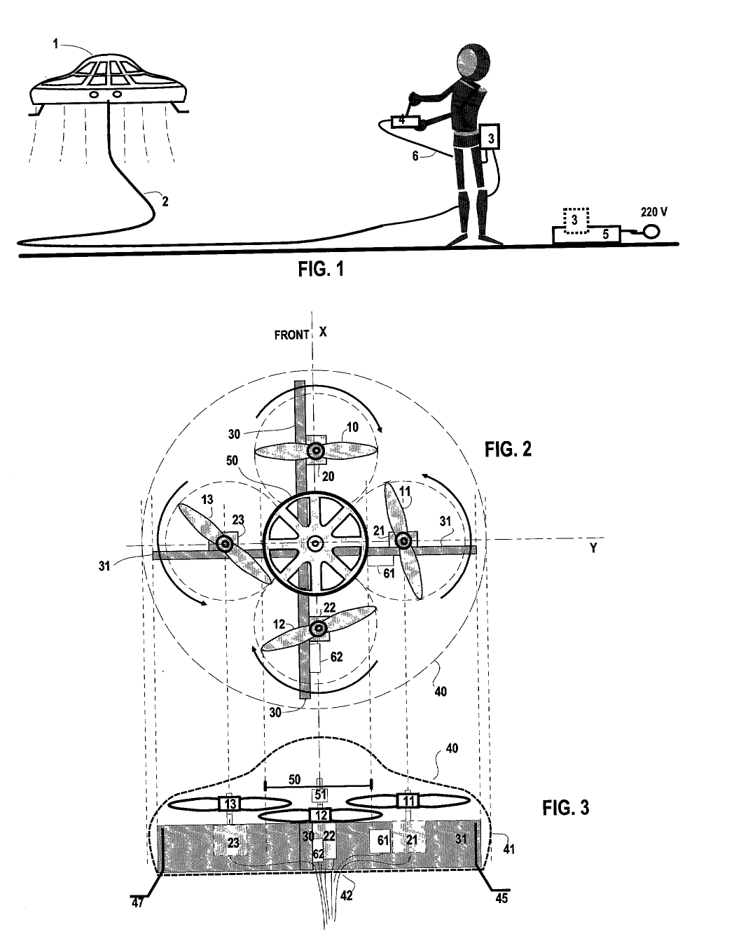

The aircraft (1) has a general shape looking like a flying saucer, as shown in FIG. 1. It is linked to the control unit (3) by a multi-wire flexible cable (2).

The handling unit (4) is handled by the user and is linked to the control unit (3) by a multi-wire flexible cable (6).

The control unit (3) is either carried by the user or either may be plugged into a loading base (5) that is connected to the mains.

AIRCRAFT (1)

As shown in drawings FIG. 2 and FIG. 3, the aircraft includes four propellers (10), (11), (12), (13) with vertical axis, that provides the lift thrust. The propellers are arranged in a square pattern, in a horizontal plan.

Each propeller is driven independently by an electric motor. The propeller (10) is driven by the motor (20). The propeller (11) is driven by the motor (21). The propeller (12) is driven by the motor (22). The propeller (13) is driven by the motor (23).

The frame that bears the motors is made of two rectangular boards (30) and (31) , arranged in a vertical plane and that intersect in the central part of the aircraft.

The board (30) bears the motors (10) and (12). The other board (31) bears the motors (11) and (13), as shown in drawing FIG. 14.

The propellers (10) and (12) rotate clockwise. The propellers (11) and (13) rotate anticlockwise. As the propellers rotate at similar speeds, the summation of the reaction torques, for the entire aircraft, is low.

The propellers (10) and (12) shown in the drawing FIG. 3 are situated in a horizontal plane slightly below the propellers (11) et (13), in order to achieve an overlapping of the areas swept by the propellers, thus enabling a reduced overall size arrangement.

At the center of the aircraft a gyroscopic rotor is situated in a horizontal plane on top of the propellers planes. This gyroscopic rotor is driven by a fifth electric motor (51). This rotor, with a high rotational speed, is intended to create an important inertia momentum, which gives a stability along the vertical axis to the aircraft. The gyroscopic stiffness of this rotor slows down the pitch and roll oscillations, so that the closed loop control (which will be detailed further) have enough time to perform the corrections to the aircraft attitude deviations.

The rotor has the following characteristics: its mass is located on the peripheral area, its balancing is accurate, the interior area includes large holes in order to allow the flow of air induced by the propellers go through the gyroscopic rotor. The gyroscopic rotor is flat, it does not participate in the thrust. It has a very low aerodynamic drag, and the reaction torque for the aircraft is thus also very low.

The motors (21), (22), (23), (24) et (51) are electric motors, of direct current type. The power supply wires go out of the aircraft through a hole (42) in the body, located at the middle of the bottom area.

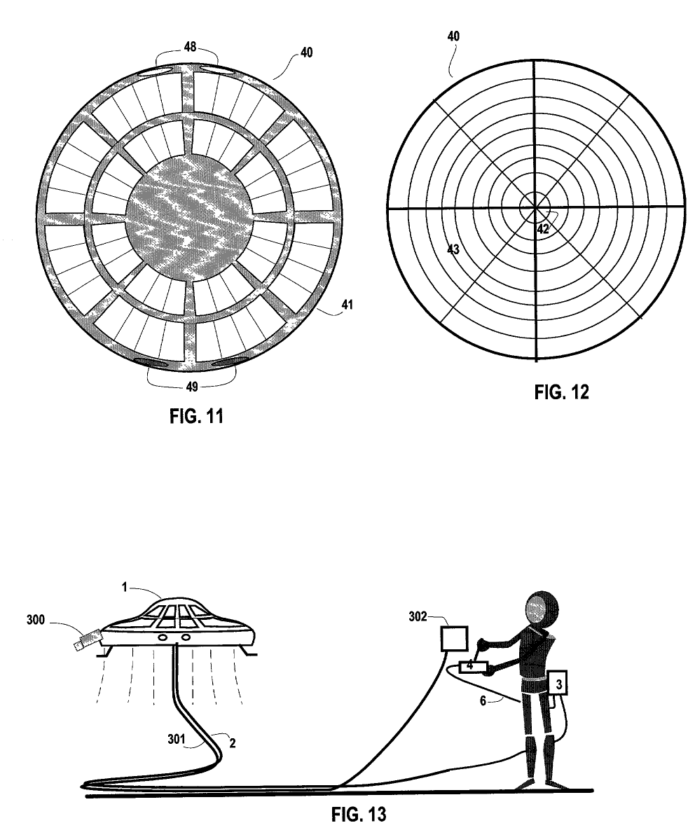

The body (40) is a protection casing with grid-type areas that let the air flow go through the aircraft, as shown in drawings FIG. 11 and FIG. 12. The grid-type areas include a protection net (43) that prevents the introduction of a finger inside the aircraft. The side area (41) is solid and is attached to boards (30) and (31). The top and bottom areas are fully holed and only consists in the protection net (43).

The protection casing is made of flexible plastic material, in order to dampen shocks if the aircraft hits another object or if the aircraft crash onto the ground after a failure. The purpose of the external casing is also to prevent that a partial or total breaking of the rotating elements go out of the aircraft. The external casing thus provides the required level of safety, specially when this device is used as a toy.

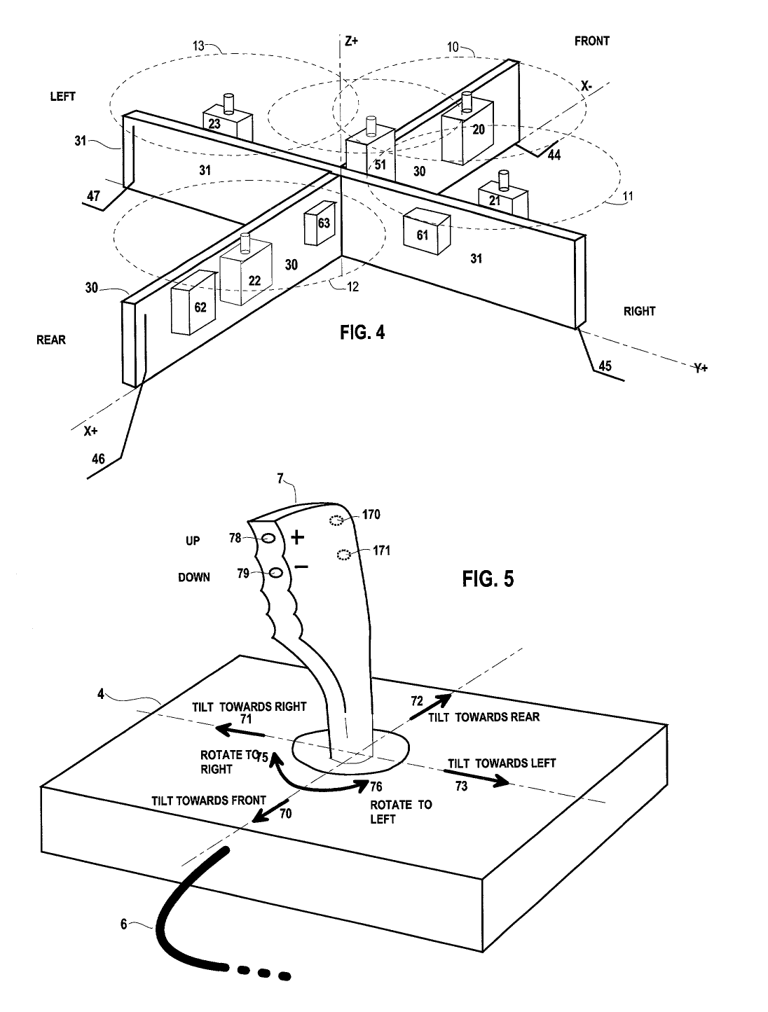

The four legs (44), (45), (46) and (47) are fastened on the boards (30) and (31), as shown in the drawings FIG. 3 and FIG. 4. These legs are also made of flexible plastic material in order to dampen the bouncing when the aircraft lands.

The front part of the aircraft is where the propeller (10) is located. It can be recognized by the presence of a picture that simulates white headlights (48), as shown in drawing FIG. 11. The rear part of the aircraft is where the propeller (12) is located. It can be recognized by the presence of a picture that simulates red lights (49). In another variant of the invention, the aircraft is fitted with headlights lamps at the front part and a sound generator device.

The aircraft is fitted with three attitude sensors whose purpose is to provide information for the closed loop control. Those sensors are located as shown in FIG. 4.

There are two tilt sensors:

The sensor (61) is of the single axis type and measures the roll tilt angle: it gives the right-left tilt angle deviation from the horizontal reference. The sensor (62) is of the single axis type and measures the pitch tilt angle: it gives the front-rear tilt angle deviation from the horizontal reference.

In another variant of the invention, the sensors (61) and (62) can be advantageously replaced by a one double axis sensor that simultaneously measures roll and pitch angles.

The yaw sensor (63) is made of a miniature gyrocompass device. Its cinetic momentum is directed along X axis. It is located near the center of the aircraft.

The functional use of these sensors and the closed loop control will be detailed further.

HANDLING UNIT (4) and HANDLE (7)

The handling unit includes a handle (7) and is linked to the control unit via the cable (6).

The drawing FIG. 5 shows the handling unit.

The tilting of the aircraft towards the front side is achieved by pushing the handle towards the direction (70).

The tilting of the aircraft towards the rear side is achieved by pulling the handle towards the direction (72). The tilting of the aircraft towards the right side is achieved by pushing the handle towards the direction (71). The tilting of the aircraft towards the left side is achieved by pushing the handle towards the direction (73). The rotation of the aircraft towards the right (clockwise direction from top view) is achieved by turning the handle towards the direction (75).

The rotation of the aircraft towards the left (anticlockwise direction from top view) is achieved by turning the handle towards the direction (76).

The switch (78) is used to increase simultaneously the rotation speed of the four propellers. The switch (78) is activated by the forefinger of user's hand.

The switch (79) is used to decrease simultaneously the rotation speed of the four propellers. The switch (79) is activated by the middle finger of user's hand.

An elastic system tends to restore the handle in the central position when there is not any stress on the handle.

In a variant of the invention, the activation of the button 170 activates the lights of the aircraft, the activation of the button 171 activates the auditive signal of the aircraft. The buttons 170 and 171 are activated by the thumb of the user.

CONTROL UNIT (3) AND ELECTRICAL CIRCUIT DIAGRAMS

The general view of the control unit (3) is shown on the drawing FIG. 7.

This unit includes an electric rechargeable battery (80) which allows to supply enough current to the five electric motors of the aircraft for several minutes. Its also includes an electronic circuit (81) which controls the flight of the aircraft.

The function of the control unit (3) is to control the speed of each electric motor by adjusting the current in each of them by a pulse width modulation (PWM) current drive. The duty cycle of each one is calculated by the micro-controller (84).

The power interface is made of a power electronic circuitry (82) which includes the four power transistors (170), (171), (172) and (173) that drive the current in each of the control lines (120), (121), (122) and (123) according to the PWM control signals from the microcontroller.

The control unit also includes a ON/OFF switch (102) allowing the user to switch on or to switch off the control unit (3) as well as the positive supply (101) of the aircraft.

According to the invention, the control unit also includes two contacts for the interface with the recharge base the positive power supply terminal (191) and the ground terminal (190).

Inside the control unit, the ground potential is distributed to various components: the aircraft ground is the line (100), the ground line for the handling unit is the line (140).

The electronic circuit (81) provides the regulated tension <<Vreg >> (130) used by the tilt sensors, by the yaw movement sensor, and by the handling unit.

The electronic circuit (81) receives the signals coming from the various attitude sensors. The signal (131) is an analog signal coming from the tilt sensor (61). The signal (132) is an analog signal coming from the tilt sensor (62). The signal (133) is an analog signal coming from the yaw movement sensor (63).

The electronic circuit (81) receives as well the signals coming from the handling unit. The signal (150) is an analog signal coming from the forward-backward control. The signal (151) is an analog signal coming from the right-left tilt control. The signal (152) is an analog signal coming from the right-left rotation control. The signal (153) is an analog signal coming from the up-down movement control.

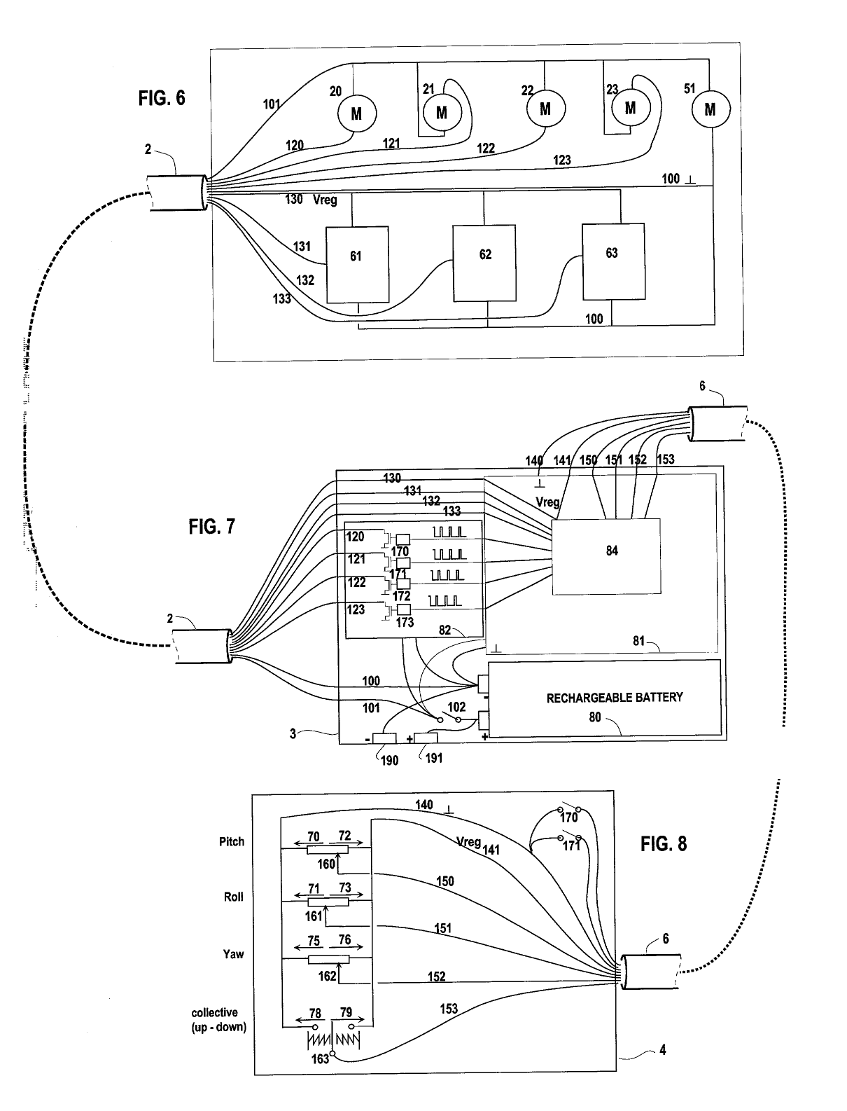

The drawing FIG. 6. is the aircraft electrical circuit diagram.

The positive supply of the five motors is a common line (101).

The line (120) controls by the negative pole the motor (20) which drives the propeller (10). The line (121) controls by the negative pole the motor (21) which drives the propeller (11). The line (122) controls by the negative pole the motor (22) which drives the propeller (12). The line (123) controls by the negative pole the motor (23) which drives the propeller (13).

The polarity of the motors (21) and (23) is reversed in order to have a rotation of these motors in the opposite direction compared to the rotation direction of the motors (20) and (22).

The motor (51) is simply supplied between the lines (100) and (101).

The positive supply <<Vreg >> for the tilt sensors (61), (62) and for the yaw movement sensor (63) comes from the line (130). This voltage is regulated, for example 5 volts, to ensure that measuring data from the sensors are not influenced by the fluctuations of the current consumption on the rechargeable battery.

The ground supply for the tilt sensors (61), (62) and for the yaw movement sensor (63) comes from the line (100).

On the line (131), an analog voltage is provided by the roll sensor (61): the voltage supplied is proportional to the angle deviation of the aircraft body relative to the normal horizontal position (rotation by the X axis). The voltage delivered is equal to half the Vreg tension if the angle deviation is null. It is greater than half of Vreg is the angle deviation is positive. It is lesser than half of Vreg is the angle deviation is negative.

On the line (132), an analog voltage is provided by the pitch sensor (62): the voltage supplied is proportional to the angle deviation of the aircraft body relative to the normal horizontal position (rotation by the Y axis). The voltage delivered is equal to half the vreg tension if the angle deviation is null. It is greater than half of Vreg is the angle deviation is positive. It is lesser than half of Vreg is the angle deviation is negative.

On the line (133), an analog voltage is provided by the yaw movement sensor (63): the voltage supplied is proportional to the rotation speed of the aircraft body relative to the Z axis. The sensor use the precession effect generated by the gyrocompass device as the aircraft rotates along the Z axis.

The voltage delivered is equal to half the Vreg tension if the rotation speed is null. It is greater than half of Vreg is the rotation speed is positive. It is lesser than half of Vreg is the rotation speed is negative.

The electric circuit diagram of the handling unit is disclosed in FIG. 8.

The handling unit is supplied by the ground (140) and by the positive Vreg tension (141).

The movements of the handle inside the handling unit displace cursors and, for each of the control directions, make the analog voltage change according to the handle position.

For the pitch control, the movement of the handle displaces the cursor (160) towards the direction (70) or (72). The voltage supplied by the cursor (160) is proportional to the position of the handle. When there is no effort on the handle, the voltage supplied is half of Vreg. When the handle is pushed towards the direction (70), the voltage decreases. When the handle is pulled towards the direction (72), the voltage increases.

For the roll control, the movement of the handle displaces the cursor (161) towards the direction (71) or (73). As for the pitch control, the voltage supplied by the cursor (161) is proportional to the position of the handle.

For the yaw movement control, the movement of the handle displaces the cursor (162) towards the direction (75) or (76). As for the pitch or roll control, the voltage supplied by the cursor (162) is proportional to the position of the handle.

For the up and down movement control, the information supplied by the handle is binary. When the button +(78) is activated, the voltage supplied by the electric switch (163) is the ground voltage. When the button-(79) is activated, the voltage supplied by the electric switch (163) is the Vreg voltage.

In another embodiment of the invention, the switch (170) delivers an information to the control unit to switch on the lights of the aircraft. The switch (171) delivers an information to the control unit to switch on the auditive signal of the aircraft.

CLOSED LOOP CONTROL

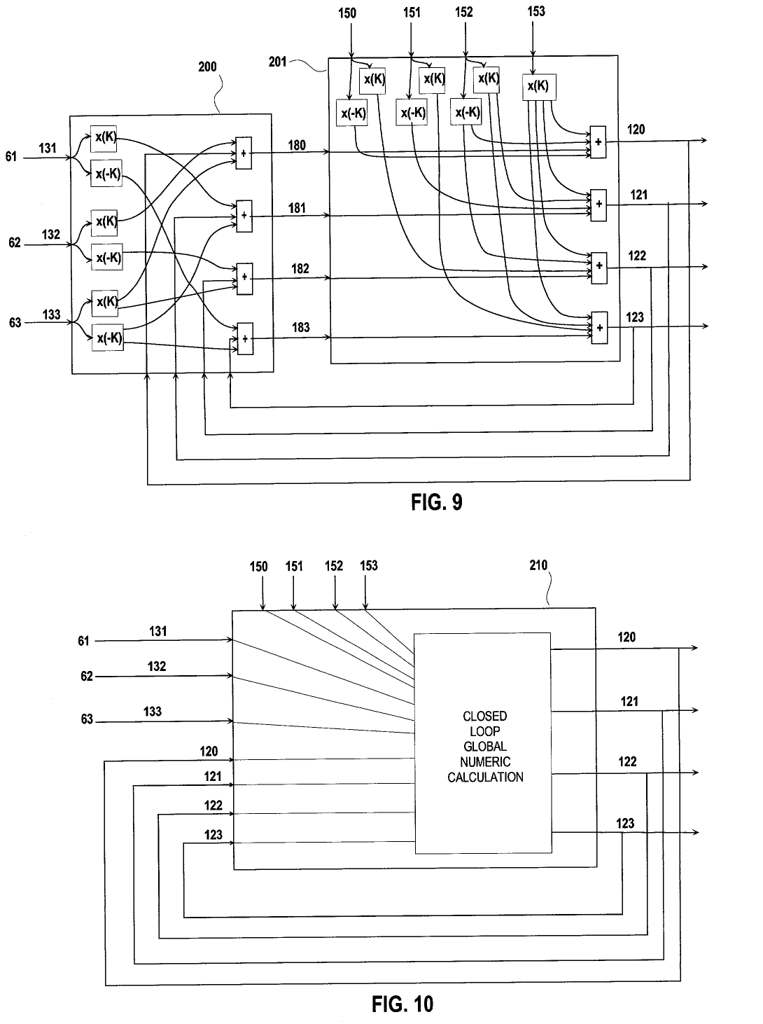

The closed loop control of the aircraft flight is shown on drawings FIG. 9. and FIG. 10.

The values of the current to be driven through each electric motor are the result of a calculation performed by a microcontroller (84).This calculation is intended to perform the flight control on a stable attitude for the aircraft (1).

When there is no action on the handle, the control loop uses the data coming from the various sensors (61), (62) and (63) to converge towards the horizontal normal attitude of the aircraft and to cancel the yaw movement.

The altitude position along the Z axis is not controlled, but when the thrust is greater than the aircraft weight, the aircraft goes up and the weight of the cable (2) lifted by the aircraft increases. A balance altitude is thus reached.

When there is an action on the handle (7), the microcontroller corrects the present required values driven in each electric current to generate an imbalance in the direction required by the handle position. This imbalance is limited by the microcontroller calculation in order to limit the displacement speed of the aircraft and also in order to allow a quick stabilization as soon as the action on the handle stops.

In the embodiment shown on FIG. 9., the required values are calculated in two successive steps.

The first step (200) consists in calculating the corrections to the four propellers speed to reduce the attitude deviation in relation to the ideal attitude (aircraft in horizontal stance and no yaw movement).

Pitch control:

If the information supplied by the sensor (62) indicates that the aircraft is tilting towards the front, then the correction consists in increasing the speed of the propeller (10), decreasing the speed of the propeller 12, meanwhile the speeds of the propellers 11 and 13 remain unchanged.

On the contrary, if the information supplied by the sensor (62) indicates that the aircraft is tilting towards the rear, then the correction consists in increasing the speed of the propeller 12, decreasing the speed of the propeller 10, meanwhile the speeds of the propellers 11 and 13 remain unchanged.

Roll control:

If the information supplied by the sensor (61) indicates that the aircraft is tilting towards the right side, then the correction consists in increasing the speed of the propeller 11, decreasing the speed of the propeller 13, meanwhile the speeds of the propellers 10 and 12 remain unchanged.

If the information supplied by the sensor (61) indicates that the aircraft is tilting towards the left side, then the correction consists in increasing the speed of the propeller 13, decreasing the speed of the propeller 11, meanwhile the speeds of the propellers 10 and 12 remain unchanged.

It is important to notice that these pitch and roll corrections do not change the overall reaction torque, because the corrections compensate for each other.

Yaw movement control:

If the information supplied by the sensor (63) indicates that the aircraft is rotating in the clockwise direction (towards the right), then the correction consists in increasing the speeds of the propellers 10 and 12, and in decreasing of the same amount the speeds of the propeller 11 and 13.

If the information supplied by the sensor (63) indicates that the aircraft is rotating in the anti-clockwise direction (towards the left), then the correction consists in increasing the speeds of the propellers 11 and 13, and in decreasing of the same amount the speeds of the propeller 10 and 12.

These corrections of the yaw movement use the change of the overall reaction torque to make the aircraft turn in the desired direction around the Z axis.

It is important to notice that all these corrections (pitch, roll and yaw movement corrections) do not change the overall vertical thrust, because the summation of the four propellers speeds keep roughly constant.

These attitude correction calculations are performed simultaneously and the output of this calculation give four new required values (180), (181), (182) and (183) for the propellers speeds.

The second step (201) of the closed loop control calculation consists in modifying the above mentioned values according to the actions done on the handle of the handling unit (7).

When the handle in tilted towards the direction 70, the voltage input on the line 150 generates the following correction: increase the speed of the propeller 12 and decrease of the same amount the speed of the propeller 10, the other speeds remain unchanged.

When the handle in tilted towards the direction 72, the voltage input on the line 150 generates the following correction: increase the speed of the propeller 10 and decrease of the same amount the speed of the propeller 12, the other speeds remain unchanged.

When the handle in tilted towards the direction 71, the voltage input on the line 151 generates the following correction: increase the speed of the propeller 13 and decrease of the same amount the speed of the propeller 11, the other speeds remain unchanged.

When the handle in tilted towards the direction 73, the voltage input on the line 151 generates the following correction: increase the speed of the propeller 11 and decrease of the same amount the speed of the propeller 13, the other speeds remain unchanged.

When the handle in rotated towards the direction 75, the voltage input on the line 152 generates the following correction: increase simultaneously the speed of the propellers 11 and 13 and decrease of the same amount the speed of the propellers 10 and 12.

When the handle in rotated towards the direction 76, the voltage input on the line 152 generates the following correction: increase simultaneously the speed of the propellers 10 and 12 and decrease of the same amount the speed of the propellers 11 and 13.

When the switch 78 is activated, the voltage input on the line 153 generates a simultaneous increase of the four propeller speeds.

When the switch 79 is activated, the voltage input on the line 153 generates a simultaneous decrease of the four propeller speeds.

These calculations, intended to correct the required values, according to the handle position, are performed simultaneously altogether and the calculation limits the unbalance introduced by the information coming from the handle position sensors. The output of this calculation give four new required values (120), (121), (122) and (123) for each propeller current and thus four new propeller target speed.

The whole close loop calculus is performed at each moment in real time.

In another embodiment of the invention, showed on drawing FIG. 10., all the calculations are performed in one step (210) and use classical numeric control algorithms: proportional, derivative and integral corrections.

Another feature of the microcontroller software is to allow the aircraft takeoff only after a certain time of power supply of the gyroscopic device, so that the normal speed of the gyroscopic device is reached before the takeoff, thus enabling the vertical stability as soon as the flight begins.

LOADING BASE (5)

The loading base is one of the known type. It is connected to the mains by a standard plug. It contains a slot that can receive either the control unit (3) or only the rechargeable battery (80) in the case of the alternate use of 2 batteries.

SPECIAL EMBODIMENT WITH MICRO-VIDEOCAMERA

In another embodiment of the invention, the aircraft has an on-board miniaturized video-camera (300) in the front area as shown in FIG. 13. The video cable (301) comes along the other power supply cable (2) that link the aircraft to the ground. A video monitor (302) is held by the user to display the images shot by the video camera.

The goal of this embodiment is to propose a system of remote inspection particularly suitable to inspect components or buildings located at a high position and uneasy to reach.

Other variants can be imagined, by adding to the micro camera a tool designed to perform some remote working. One example is the operation of destroying a nest of dangerous insects by spraying an insecticide carried by the aircraft.

INVENTION ADVANTAGES

One of the advantage of the invention is to propose an aircraft system which is enjoyable and educative, particularly suitable for the training to control an helicopter-like aircraft.

Another advantage of the invention is to propose, with an on-board micro video camera, a very useful system of remote inspection.

EXEMPLE OF DIMENSIONS FOR THE TOY VERSION

Propeller diameter: 15 to 20 cm

aircraft diameter: 50 cm

aircraft weight 400 g

Voltage: 14 V

Rechargeable battery capacity: 1,5 A.h

We claim:

1] Aircraft, supplied by electric power source, remotely supplied and remotely controlled by the means of a flexible cable, including four propellers and a gyroscopic device, comprising the improvement of being able to perform stationary flight and able to move in a controlled way in the three space dimensions:

2] Aircraft according to claim [1], wherein the electric power source is a rechargeable battery, either carried by the user or laid on the ground.

3] Aircraft according to any of the claims [1] to [2], wherein the propulsive means consist in four propellers, each of them driven by a direct current electric motor, 2 propellers rotating clockwise, situated in opposite positions, and 2 propellers rotating anti-clockwise, situated in opposite positions.

4] Aircraft according to any of the claims [1] to [3], wherein the current driven for each electric motor coupled to propellers is controlled through the means of a pulse width modulated current drive performed by an off-board electronic control device.

5] Aircraft according to any of the claims [1] to [4], wherein the control device is a single handle allowing the control of the pitch movement, the roll movement, the yaw movement, and the going up movement and the going down movement.

6] Aircraft according to any of the claims [1] to [5], comprising moreover tilt sensors relative to vertical direction, and a close loop control achieving, when there is no action on the handle, to maintain the device in the horizontal position.

7] Aircraft according to any of the claims [1] to [6], comprising moreover a gyrocompass device that measures the yaw movement and a close loop control allowing, when there is no action on the handle, to avoid any yaw movement.

8] Aircraft according to any of the claims [1] to [7], comprising moreover an on-board miniaturized video camera linked to a video display carried by the user.

9] Method of controlling the aircraft disclosed in any of the claims [1] to [8], comprising a closed loop control using the tilt sensors and the yaw movement sensor in order to achieve the keeping of the aircraft in the ideal horizontal position, through the means of the control of the current driven in each of the four electric motors.

10] Method of controlling the aircraft disclosed in the claim [9], wherein the system uses the movements performed on the handle unit to generate an aircraft attitude deviation in term of roll, pitch, yaw, going up, going down movements that induces the desired displacement of the aircraft.
